(19) United States
(12) Patent Application Publication
(10) Pub. No.: US 2022/0332259 A1
(43) Pub. Date: Oct. 20, 2022

(54) SYSTEMS AND METHODS FOR A VIBRATION DAMPING MOUNT

(71) Applicant: Capivara Industries LLC, Phoenix, AZ (US)

(72) Inventor: William Jordan, Mesa, AZ (US)

(73) Assignee: Capivara Industries LLC, Phoenix, AZ (US)

(21) Appl. No.: 17/722,267

(22) Filed: Apr. 15, 2022

Related U.S. Application Data
(60) Provisional application No. 63/175,189, filed on Apr. 15, 2021.

(51) Int. Cl. B60R 11/02; F16F 15/06; F16F 15/00

(52) U.S. Cl. CPC B60R 11/0229; F16F 15/06; F16F 15/002

(57) ABSTRACT

A vibration damping mount is disclosed that is designed to be mounted to a vehicle such as a car, truck, ATV or boat and accommodate an electronic device with a screen. The vibration damping mount may be mounted by a bracket, bolts, a clamp, or other coupling means. The vehicle-mounted portion and device-mounting portion of the vibration damping mount may generally be connected by a piston having springs on either side to absorb vibrational energy from the motion of the vehicle the system is mounted to, thereby reducing vibration of the screen of any electronic device mounted to the system. The springs may be further tuned by tightening or loosening tuning screws in contact with the springs, thereby increasing or decreasing the force of the springs on the piston. This allows the vibration damping mount to be adapted to a variety of vehicles and circumstances.

### CROSS-REFERENCE TO RELATED APPLICATIONS

This application claims priority to U.S. Provisional Application Ser. No. 63/175,189 to William Jordan entitled “Systems and Methods for a Vibration Damping Mount” filed on Apr. 15, 2021.

### BACKGROUND

### 1. Technical Field

Aspects of this document relate generally to systems and methods for vibrational damping of a display screen mounted in or on a vehicle.

### 2. Background Art

The use of computerized devices having a digital display screen in or on a vehicle has grown increasingly common. Such devices may be used for displaying directions and/or a map, electronic communications, selection of audio content, Internet searching, recording video or audio content, etc. Current mounting devices for such digital displays or cameras create challenges to a user's ability to clearly view the display screen when the vehicle to which the display screen is mounted is in motion, particularly when the vehicle is in motion over rough terrain, due to the vibration and motion of the display screen in accordance with the bouncing and gyration of the vehicle when traversing such terrain.

### SUMMARY

Implementations of a vibration damping mount may comprise a bracket comprising a substantially planar bottom member, one or more vertical extension members extending from the substantially planar bottom member, and one or more side brackets coupled to each of the one or more vertical extension members at a point distal to the substantially planar bottom member. The vibration damping mount may further comprise one or more tube assemblies coupled to the side bracket, the one or more tube assemblies comprising a hollow tube comprising an opening at a medial portion of the hollow tube and running longitudinally along the hollow tube. The one or more tube assemblies may further comprise a piston configured to fit within the hollow tube, the piston comprising a first plurality of coupling channels oriented substantially perpendicular to the hollow tube, and a spring configured to fit within the first hollow tube and remain in contact with the piston. The vibration damping mount may further comprise a face plate coupled to the one or more tube assemblies.

Particular aspects may comprise one or more of the following features. The one or more tube assemblies may further comprise a tuning screw configured to fit within the hollow tube and remain in contact with the spring, the tuning screw further configured to adjust within the hollow tube such that when the tuning screw is tightened the tuning screw compresses the spring against the piston and when the tuning screw is loosened, the tuning screw reduces compression of the spring with the piston. The one or more tube assemblies may further comprise a spacer having a second plurality of coupling channels and configured to fit within the opening at the medial portion of the hollow tube, the second plurality of coupling channels coupled with the first plurality of coupling channels and further coupled to the one or more side brackets. The vibration damping mount may further comprise a first rosette coupled to the one or more vertical extension members and a second rosette coupled to the side bracket, the second rosette configured to interface with the first rosette. The face plate may be configured to removably couple to a device comprising a display screen. At least one of the first rosette and the second rosette may be a crown gear. The device to which the face plate is configured to couple comprises at least one of a navigation system, a mapping system, a computerized tablet, a mobile phone, an audio device, a video device, or a smart device.

Implementations of a vibration damping mount may comprise one or more tube assemblies comprising a hollow tube, a piston configured to fit within the hollow tube, the piston comprising a thread running at least partially therethrough, a spring configured to fit within the hollow tube and remain in contact with the piston, and a mounting component coupled at an end of the thread, the mounting component configured to fit within a clamp. The vibration damping mount may further comprise a face plate coupled to the one or more tube assemblies.

Particular aspects may comprise one or more of the following features. The one or more tube assemblies may further comprise a tuning screw comprising a channel therethrough, the tuning screw configured to fit within the hollow tube and remain in contact with the spring, the tuning screw further configured to adjust within the hollow tube such that when the tuning screw is tightened, the tuning screw compresses the spring against the piston and when the tuning screw is loosened, the tuning screw reduces compression of the spring with the piston, the tuning screw further configured to pass the thread of the piston therethrough. The mounting component may comprise a substantially spheroidal structure configured to fit within a ball clamp. The one or more tube assemblies may further comprise a tuning screw thru hole. The face plate may be configured to removably couple to a device comprising a display screen. The device to which the face plate is configured to couple may comprise at least one of a navigation system, a mapping system, a computerized tablet, a mobile phone, an audio device, a video device, or a smart device. The hollow tube may comprise a substantially cylindrical inner channel and an outer surface comprising a plurality of planar faces. The mounting component may further comprise a substantially planar coupling base, the substantially planar coupling base comprising a plurality of coupling slots each configured to couple with a thread of the one or more tube assemblies.

Implementations of a vibration damping mount may comprise one or more tube assemblies comprising a hollow tube, a piston configured to fit within the hollow tube, a spring configured to fit within the hollow tube and remain in contact with the piston, and a mounting component coupled to the piston, the mounting component configured to fit within a clamp. The vibration damping mount may further comprise a mount body integrally forming the hollow tube and through which the hollow tube extends.

Particular aspects may comprise one or more of the following features. The mounting component may comprise a substantially spheroidal structure configured to fit within a ball clamp. The mount body may be configured to couple to a device comprising a display screen via a plurality of mounting channels. The device to which the mount body is configured to couple may comprise at least one of a navigation system, a mapping system, a computerized tablet, a mobile phone, an audio device, a video device, or a smart device. The mount body may comprise a primary mount body through which the hollow tube extends, the hollow tube comprising an opening proximal a medial portion of the hollow tube and a secondary mount body comprising a coupling channel therethrough, the coupling channel positioned to align with at least a portion of the opening proximal the medial portion of the hollow tube of the primary mount body and a complementary coupling channel of the piston. The mounting component may further comprise a substantially planar coupling base, the substantially planar coupling base comprising a plurality of coupling slots each configured to couple with piston of the one or more tube assemblies. The one or more tube assemblies may further comprise at least one of a tuning screw comprising a channel therethrough, the tuning screw configured to fit within the hollow tube and remain in contact with the spring, the tuning screw further configured to adjust within the hollow tube such that when the tuning screw is tightened, the tuning screw compresses the spring against the piston and when the tuning screw is loosened, the tuning screw reduces compression of the spring with the piston, the tuning screw further configured to pass the thread of the piston therethrough and a spacer configured to couple to the piston and extend through the coupling channel of the secondary mount body.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventor is fully aware that he can be his own lexicographers if desired. The inventor expressly elects, as his own lexicographer, to use only the plain and ordinary meaning of terms in the specification and claims unless he clearly state otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of post-AIA 35 U.S.C. § 112(f). Thus, the use of the words “function,” “means” or “step” in the Description, Drawings, or Claims is not intended to somehow indicate a desire to invoke the special provisions of post-AIA 35 U.S.C. § 112(f), to define the invention. To the contrary, if the provisions of post-AIA 35 U.S.C. § 112(f) are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of post-AIA 35 U.S.C. § 112(f). Moreover, even if the provisions of post-AIA 35 U.S.C. § 112(f) are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS.

### BRIEF DESCRIPTION OF THE DRAWINGS

Implementations will hereinafter be described in conjunction with the appended drawings, where like designations denote like elements, and:

FIGS. 1A-C depict exploded, perspective, and front views of an embodiment for a vibration damping mount, respectively.

FIGS. 2A-C depict exploded, front, and side views of an embodiment of a vibration damping mount comprising a piston and mounting component on two sides of a face plate, respectively.

FIGS. 3A-C depict exploded, front, and side views of an embodiment of a vibration damping mount comprising a piston and mounting component on each end of the piston and on two sides of a face plate, respectively.

FIGS. 4A-C depict an exploded, perspective and side view of an embodiment of a vibration damping mount comprising a plurality of bores through the mounting body and a mounting component at one end of the mounting body, respectively.

FIGS. 5A-B depict exploded and perspective views of an embodiment of a vibration damping mount comprising a plurality of bores through the mounting body and a mounting component at two ends of the mounting body, respectively.

FIGS. 6A-C an exploded, perspective and side view of an embodiment of a vibration damping mount comprising a non-cylindrical piston and hollow channel within the mounting body, respectively.

FIGS. 7A-C depict an exploded, perspective and side view of an embodiment of a vibration damping mount comprising a body bottom portion and a body top portion.

### DESCRIPTION

This disclosure, its aspects and implementations, are not limited to the specific components or methods disclosed herein. Many additional components and assembly procedures known in the art consistent with the intended vibration damping mount and related methods will become apparent for use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

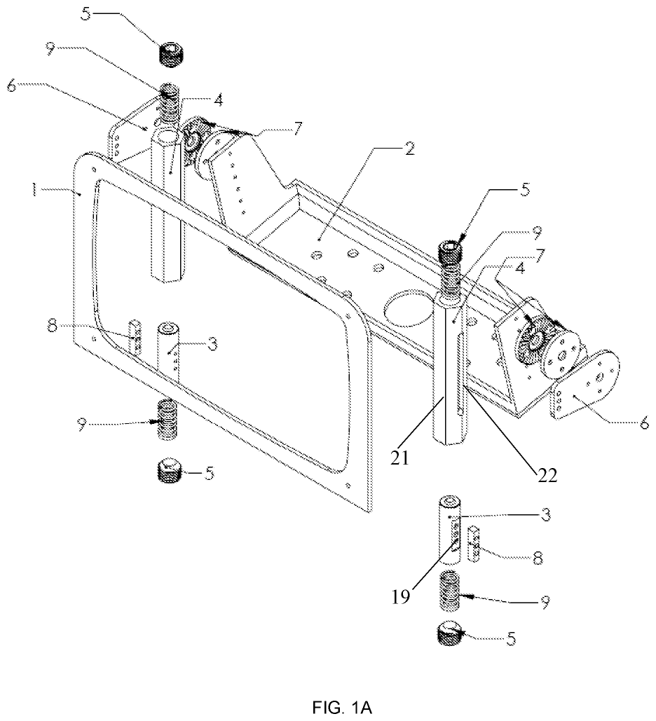

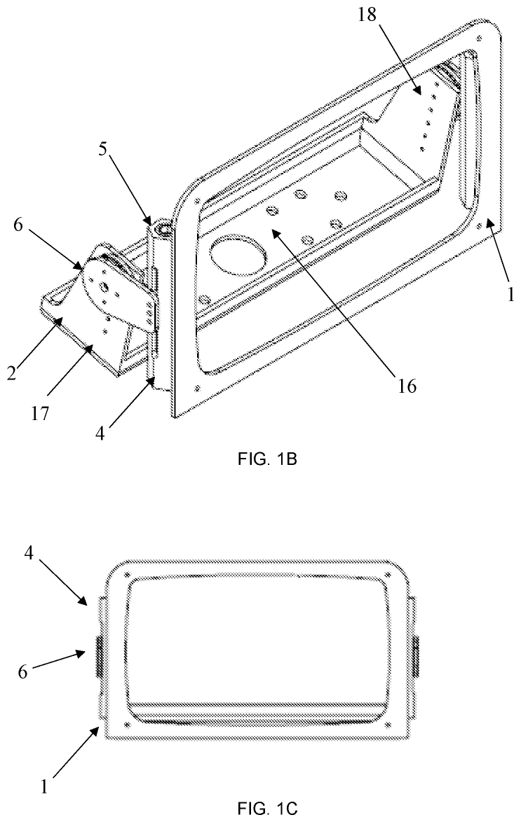

FIGS. 1A-C depict an exemplary embodiment of a vibration damping mount for a device comprising a display screen such as by non-limiting example, a navigation system, a mapping system, a computerized tablet, a mobile phone, and an audio and/or video device. The vibration damping mount may be installed in or on any vehicle such as by non-limiting example, an automobile, a truck, an all-terrain vehicle (ATV), a motorcycle, a bicycle, or a boat. As shown in FIG. 1A, the vibration damping mount may comprise a bracket 2 configured to be mounted to a vehicle. The bracket 2 may comprise a substantially planar bottom member 16, and one or more openings configured to pass one or more bolts or other fastening devices therethrough for the purpose of mounting the bracket 2 to the vehicle. It is contemplated that any variety of patterned openings may be used to accommodate securing the bracket 2 to various surfaces within or on a vehicle such as by non-limiting example, a dashboard, a roll cage, a grab bar, etc. As shown the bracket 2 comprises vertical extension members 17 extending upward from a substantially planar bottom member of the bracket 2, the vertical extension members 17 positioned at first and second ends of the planar bottom member 16 of the bracket 2. These vertical extension members 17 may further comprise one or more openings 18 configured to pass a bolt or other fastener therethrough. As shown in some embodiments, the one or more openings 18 in the vertical extension members 17 may be positioned at various heights along the vertical extension members 17 to allow a user to select a desired positioning of the overall assembly. The vibration damping mount further comprises a face plate 1 configured to be mounted to a device comprising a display screen. The face plate 1 is shown here having a substantially rectangular shape comprising a central opening configured to accommodate a display screen of an electronic device, however the face plate 1 may comprise any appropriate shape necessary to accommodate a non-rectangular display screen. As shown, the face plate 1, may further comprise one or more securing holes therein configured to receive a bolt or other fastener as needed to mount the face plate 1 to the electronic device intended to be displayed.

In some embodiments, the vibration damping mount may comprise one or more tube assemblies 21 comprising one or more hollow tubes 4 configured to house one or more pistons 3 within the hollow portion of the hollow tube 4. As shown in FIGS. 1A-C, the hollow tubes 4 are depicted comprising a hexagonal outer shape with a substantially cylindrical hollow channel therethrough, however, it is contemplated that the hollow tubes 4 may comprise any outer shape such as by non-limiting example, a shape comprising one or more planar surfaces. The substantially cylindrical hollow channel through the hollow tube 4 may also comprise any shape configured to receive the piston 3 and allow the piston 3 to move back and forth within the hollow tube 4. The hollow tube 4 may be coupled to a rear side of the face plate 1 using any appropriate fastening means such as by non-limiting example, welding, screws, bolts, or other appropriate fasteners. As shown, the piston 3 comprises one or more coupling channels 19 therein to allow the piston 3 to be secured to a side bracket 6 through an opening 22 proximal a medial portion of the hollow tube 4. The side bracket 6 may comprise one or more complementary securing holes configured to align with the one or more coupling channels 19 of the piston 3 and receive a bolt, screw, or other fastener to secure the piston 3 to the side bracket 6. In some embodiments, a spacer 8 comprising one or more coupling channels 19 therein that are configured to align with the one or more coupling channels 19 of the piston 3 may be used to secure the piston 3 to the side bracket 6 to prevent the side bracket 6 from contacting the hollow tube 4 after assembly.

The vibration damping mount may further comprise one or more springs 9 withing the hollow channel of the hollow tube. As shown in FIG. 1A, the springs 9 may be positioned at either end of the piston 3 and secured with a tuning or set screw 5 to maintain a desired pressure on the piston 3 within the hollow tube 4. By adjusting the tension of the tuning screw 5, the pressure on the springs 9 is adjustable thereby allowing the user to tune the degree of flexibility of the springs 9 to achieve a desired degree of motion of the display screen of the electronic device that is mounted to the face plate 1 relative to the motion of the vehicle to which the vibration damping mount is coupled. It should be noted that the tuning or set screw 5 is optional as the degree of motion of the display screen may also be controlled based on the characteristics of the one or more springs 9 selected.

As shown, the vibration damping mount may further comprise a plurality of rosettes 7 each comprising a substantially planar first surface and a plurality of teeth on a second surface. In some embodiments, the rosettes 7 may comprise, by non-limiting example, a crown gear. By positioning two rosettes 7 such that the teeth of the second side of each rosette 7 are facing one another and securing the substantially planar side of a first rosette 7 to the side bracket 6 and the substantially planar side of the second rosette 7 to the vertical extension member 17 extending upward from the bottom member 16 of the bracket 2, the angle of the face plate 1 relative to the bottom member 16 of the bracket 2 may be adjusted and secured using a bolt or other fastener once the desired angle has been achieved.

When a force is applied to either the face plate 1 or the bracket 2, such as by non-limiting example, when a vehicle to which the bracket 2 is mounted is moving along uneven terrain, the piston 3 slides within the hollow tube 4 and minimizes the bouncing of the face plate 1 as well as the display screen of the device to which the face plate 1 is mounted as a result of the isolation of the display screen of the device from the vehicle. This allows the user to be better able to read and focus on information displayed on the display screen.

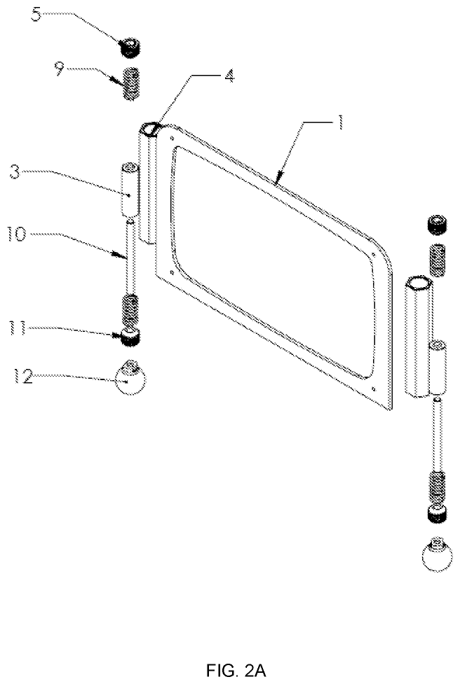

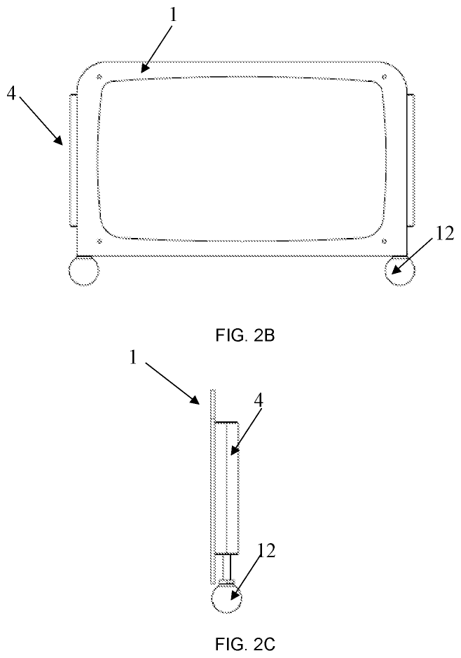

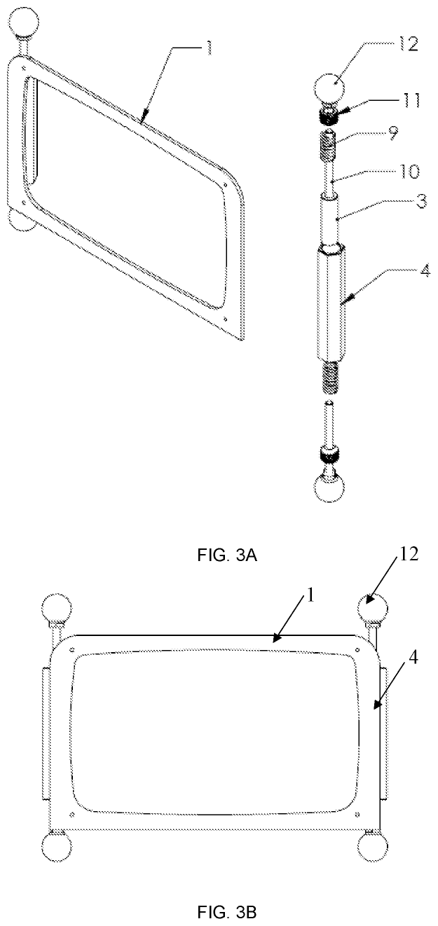

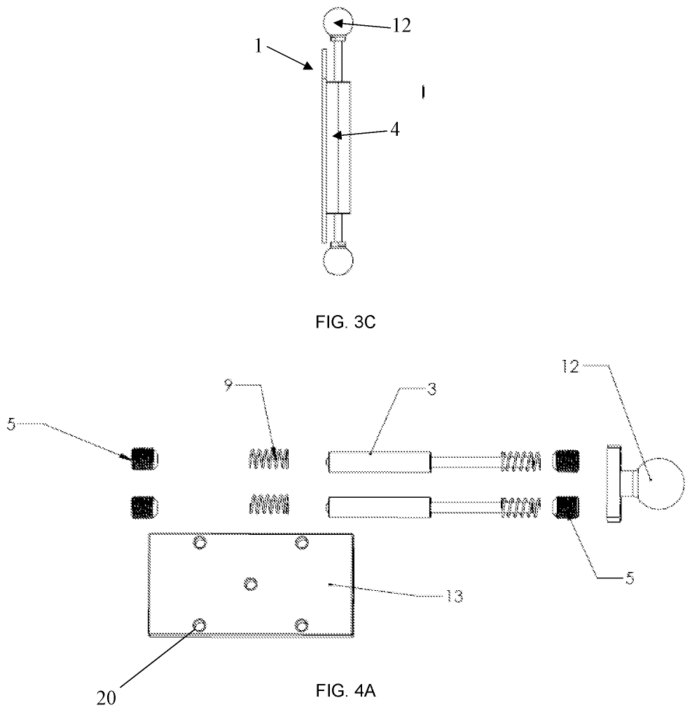

FIGS. 2A-C provide an exemplary embodiment of a vibration damping mount that allows for the face plate 1 to which the display screen is mounted to be mounted to a vehicle using a clamp or other securing device. As shown, the piston 3, thread 10, and springs 9 are configured to reside within the hollow tube 4. Set screw 5 (also referred to as a tuning screw) and the set screw thru hole 11 are optional and allow the user to adjust the tension of the springs 9 and therefore, the amount of vibration damping that will occur when the vehicle is moving; however the tension and flexibility may also be adjusted by selecting springs 9 that provide the desired range of motion in the absence of the set screw 5 and set screw thru hole 11. As shown, the system may further comprise a threaded fastener configured to couple with the thread 10 within the hollow tube 4 and to receive a mounting component 12. The mounting component 12 is shown here as a substantially spheroidal structure such as a ball which is suitable for use with a ball clamp, but other shapes or configurations of the mounting component 12 such as by non-limiting example, a mounting component having one or more holes to allow for fastening to a vehicle, may be used. As shown in FIGS. 2A-C, the vibration damping mount may comprise a single mounting component 12, such as a ball, proximal a single end of the hollow tube 4, however, as shown in FIGS. 3A-C, in some embodiments, a mounting component 12, such as a ball, may be positioned proximal both ends of the hollow tube 4 for added security when mounting to a vehicle.

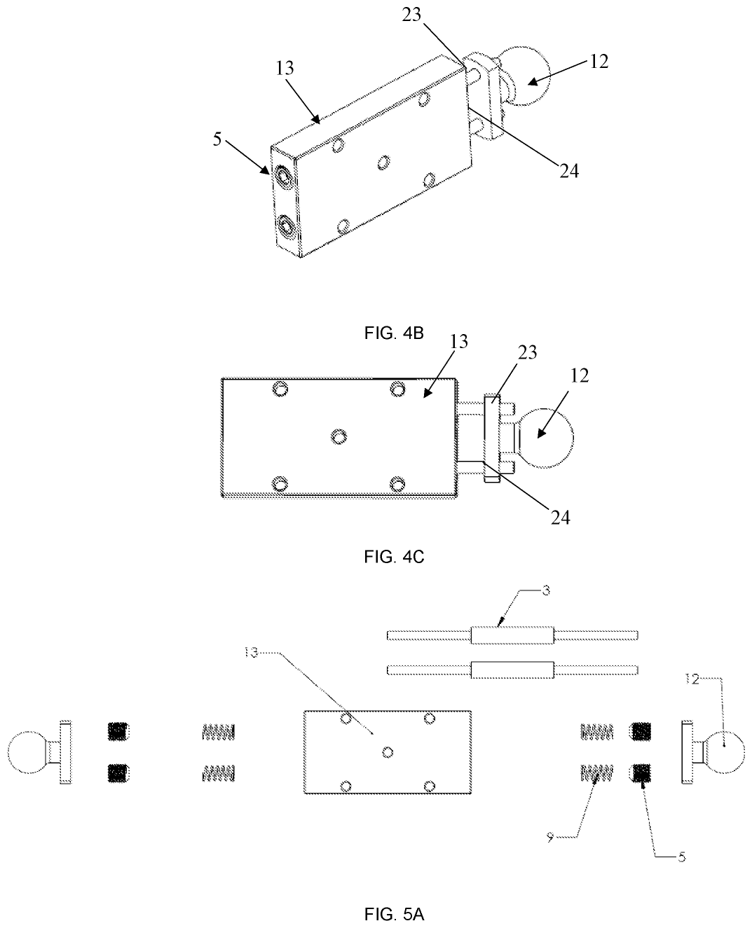

In some embodiments of a vibration damping mount, the vibration damping mount may comprise a body 13, shown in FIGS. 4A-C as being substantially rectangular in shape, however, any appropriate geometric shape necessary on which to mount an electronic device comprising a display screen is contemplated. As shown, the body 13 may comprise a plurality of mounting channels 20 such as through bores arranged in various patterns to accommodate mounting a device comprising a display screen thereto. Also as shown, the mount may comprise one or more pistons 3 (shown here as one sided, but not limited as such), comprising a spring 9 on each side of the piston 3 which may encircle a thread 10. The piston 3, thread 10, and spring 9 may be configured to pass through a hollow channel in the mount body 13. The springs 9 may optionally be secured by tuning or set screws 5 proximal to each end of the body 13. In the present configuration as shown in FIGS. 4A-C, the vibration damping mount may comprise a plurality of pistons 3, threads 10, springs 9, and set screws 5 configured to pass through a plurality of hollow bores within the body 13 of the mount. The hollow bores, also referred to as tube assemblies 22, may be integrally formed within the mount body 13. In other embodiments, a single bore may be used with corresponding components as shown to comprise the mount. As depicted in FIGS. 4A-C, which depict two tube assemblies 22 passing through the body 13 of the mount and two sets of pistons 3, threads, and springs 9, the mount may be configured to accommodate a mounting component 12 which may comprise one or more coupling slots 23 or holes with which to accept the threads 10 to allow for coupling to the mounting component 12, shown here by non-limiting example as a ball configured to mate with a ball clamp. In some embodiments, as shown here by non-limiting example, the mounting component 12 may further comprise a substantially planar coupling base 24.

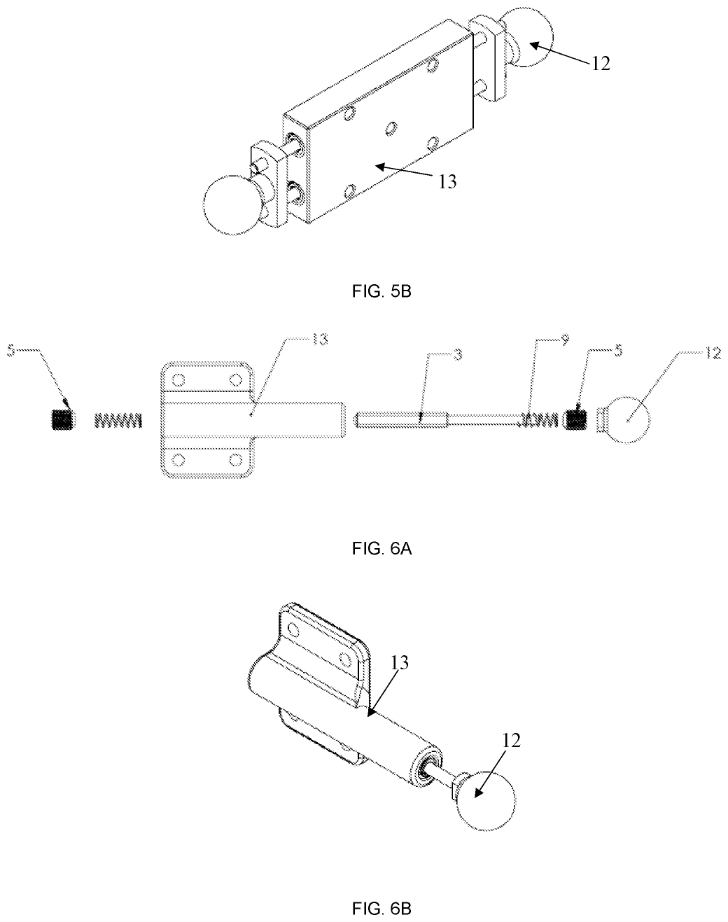

FIGS. 5A-B depict another embodiment of the vibration damping mount in which the system comprises a two-sided piston 3 configured to pass through a tube assembly 22, shown here as a hollow bore within the mount body 13. Configured similarly to the embodiment of FIGS. 4A-C described above, in this embodiment, the mount may comprise a set screw 5 and mounting component 12, (shown here by non-limiting example as a ball configured to mate with a ball clamp), at each end of the mounting body 13. As in the embodiment of FIGS. 4A-C, the embodiment of FIGS. 5A-B may comprise any configuration of one or more mounting channels 20 to which an electronic device comprising a display screen may be mounted.

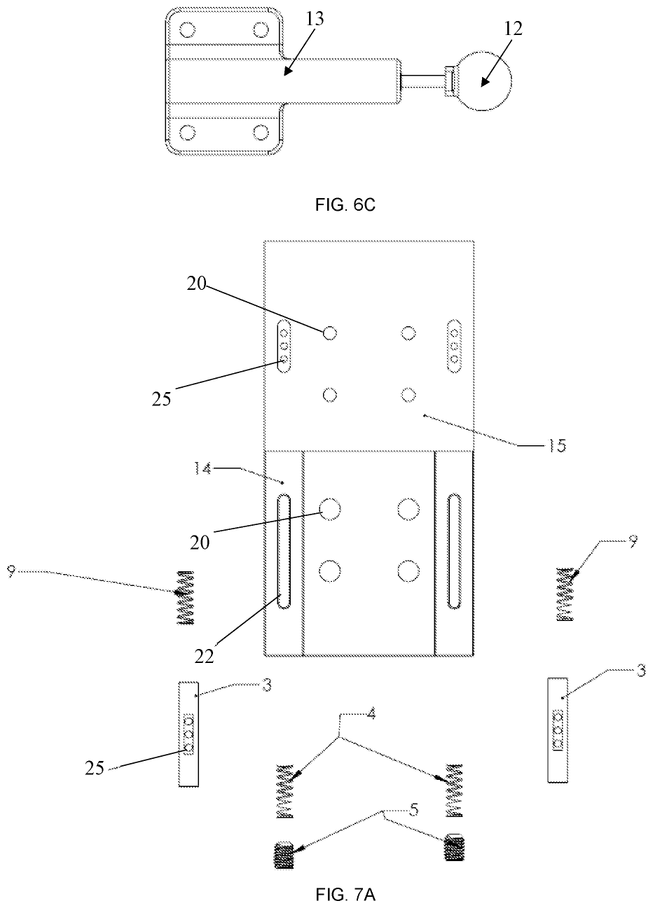

As shown in the exemplary embodiment of FIGS. 6A-C, the vibration damping mount may comprise a mounting body 13 comprising one or more mounting channels 20 configured to facilitate mounting the assembly to a vehicle. As shown, the mount may comprise a piston 3 and a thread with a spring 9 on either end of the piston 3, the piston 3, springs 9, and thread passing through a hollow channel in the mounting body 13 and optionally adjustably secured with a set screw 5 at each end of the mounting body 13. In some embodiments, the piston 3 may be cylindrical and the hollow channel in the body 13 through which the piston 3 passes may also be cylindrical and in other embodiments, the piston 3 and hollow channel within the mounting body may be of a different geometric shape than a cylinder. For example, the hollow channel and the piston may both comprise complimentary square, rectangular, triangular, or other geometric shapes so as to retard rotation of the piston 3 within the hollow channel of the mounting body 13. The mount may further comprise a mounting component 12 positioned at least one end of the mounting body 13 and coupled to the piston 3, thread, and/or set screw 5.

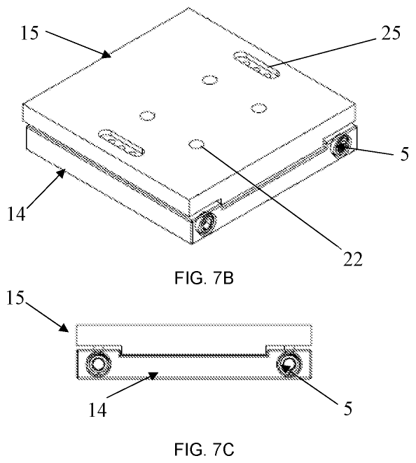

As shown in FIGS. 7A-C, in some embodiments of a vibration damping mount, the mount may comprise a primary mount body 14 configured with one or more longitudinal openings 22 or slots proximal a medial portion of a hollow tube 4 within the primary mount body 14 and one or more mounting channels 20 configured to receive an electronic device comprising a display screen. The mount may further comprise a secondary mount body 15 comprising one or more raised solid slots 25 further comprising one or more holes within the raised solid slots 25 configured to align with one or more threaded holes of the piston 3. As in previously described embodiments, pistons 3 and set screws 5 may be positioned within one or more hollow channels within the primary mount body 14. Bolts or other fasteners may be placed through the one or more mounting channels 19 of the piston 3, raised solid slots 25, and longitudinal slots 22 to secure the secondary mount body 15 to the piston 3. As a result of the raised solid slots 22 in the secondary mount body 15, the secondary mount body 15 to which an electronic device comprising a display screen is secured is able to move independently of the vehicle without being in contact with the primary mount body 14 which prevents friction wear on the assembly.

In places where the description above refers to particular implementations of systems and methods for vibration damping mounting, it should be readily apparent that a number of modifications may be made without departing from the spirit thereof and that these implementations may be applied to other to systems and methods for vibration damping of a mounted device.

I claim:

1. A vibration damping mount comprising:
a bracket comprising:
a substantially planar bottom member;
one or more vertical extension members extending from the substantially planar bottom member; and
one or more side brackets coupled to each of the one or more vertical extension members at a point distal to the substantially planar bottom member;
one or more tube assemblies coupled to the side bracket, the one or more tube assemblies comprising:
a hollow tube comprising an opening at a medial portion of the hollow tube and running longitudinally along the hollow tube;
a piston configured to fit within the hollow tube, the piston comprising a first plurality of coupling channels oriented substantially perpendicular to the hollow tube; and
a spring configured to fit within the first hollow tube and remain in contact with the piston; and
a face plate coupled to the one or more tube assemblies.

2. The vibration damping mount of claim 1, wherein the one or more tube assemblies further comprises a spacer having a second plurality of coupling channels and configured to fit within the opening at the medial portion of the hollow tube, the second plurality of coupling channels coupled with the first plurality of coupling channels and further coupled to the one or more side brackets.

3. The vibration damping mount of claim 1 further comprising:
a first rosette coupled to the one or more vertical extension members; and
a second rosette coupled to the side bracket, the second rosette configured to interface with the first rosette.

4. The vibration damping mount of claim 1, wherein the face plate is configured to removably couple to a device comprising a display screen.

5. The vibration damping mount of claim 1, wherein the one or more tube assemblies further comprise a tuning screw configured to fit within the hollow tube and remain in contact with the spring, the tuning screw further configured to adjust within the hollow tube such that when the tuning screw is tightened the tuning screw compresses the spring against the piston and when the tuning screw is loosened, the tuning screw reduces compression of the spring with the piston.

6. The vibration damping mount of claim 4, wherein the device to which the face plate is configured to couple comprises at least one of a navigation system, a mapping system, a computerized tablet, a mobile phone, an audio device, a video device, or a smart device.

7. A vibration damping mount comprising:
one or more tube assemblies comprising:
a hollow tube;
a piston configured to fit within the hollow tube, the piston comprising a thread running at least partially therethrough;
a spring configured to fit within the hollow tube and remain in contact with the piston; and
a mounting component coupled at an end of the thread, the mounting component configured to fit within a clamp; and
a face plate coupled to the one or more tube assemblies.

8. The vibration damping mount of claim 7, wherein the mounting component comprises a substantially spheroidal structure configured to fit within a ball clamp.

9. The vibration damping mount of claim 7, wherein the one or more tube assemblies further comprises a tuning screw comprising a channel therethrough, the tuning screw configured to fit within the hollow tube and remain in contact with the spring, the tuning screw further configured to adjust within the hollow tube such that when the tuning screw is tightened, the tuning screw compresses the spring against the piston and when the tuning screw is loosened, the tuning screw reduces compression of the spring with the piston, the tuning screw further configured to pass the thread of the piston therethrough.

10. The vibration damping mount of claim 7, wherein the face plate is configured to removably couple to a device comprising a display screen.

11. The vibration damping mount of claim 10, wherein the device to which the face plate is configured to couple comprises at least one of a navigation system, a mapping system, a computerized tablet, a mobile phone, an audio device, a video device, or a smart device.

12. The vibration damping mount of claim 9, wherein the hollow tube comprises a substantially cylindrical inner channel and an outer surface comprising a plurality of planar faces.

13. The vibration damping mount of claim 8, wherein the mounting component further comprises a substantially planar coupling base, the substantially planar coupling base comprising a plurality of coupling slots each configured to couple with a thread of the one or more tube assemblies.

14. A vibration damping mount comprising:
one or more tube assemblies comprising:
a hollow tube;
a piston configured to fit within the hollow tube;
a spring configured to fit within the hollow tube and remain in contact with the piston;
a mounting component coupled to the piston, the mounting component configured to fit within a clamp; and
a mount body integrally forming the hollow tube and through which the hollow tube extends.

15. The vibration damping mount of claim 14, wherein the mounting component comprises a substantially spheroidal structure configured to fit within a ball clamp.

16. The vibration damping mount of claim 14, wherein the mount body is configured to couple to a device comprising a display screen via a plurality of mounting channels.

17. The vibration damping mount of claim 16, wherein the device to which the mount body is configured to couple comprises at least one of a navigation system, a mapping system, a computerized tablet, a mobile phone, an audio device, a video device, or a smart device.

18. The vibration damping mount of claim 14, wherein the mount body comprises:
a primary mount body through which the hollow tube extends, the hollow tube comprising an opening proximal a medial portion of the hollow tube; and
a secondary mount body comprising a coupling channel therethrough, the coupling channel positioned to align with at least a portion of the opening proximal the medial portion of the hollow tube of the primary mount body and a complementary coupling channel of the piston.

19. The vibration damping mount of claim 14, wherein the mounting component further comprises a substantially planar coupling base, the substantially planar coupling base comprising a plurality of coupling slots each configured to couple with piston of the one or more tube assemblies.

20. The vibration damping mount of claim 18, wherein the one or more tube assemblies further comprises at least one of a tuning screw comprising a channel therethrough, the tuning screw configured to fit within the hollow tube and remain in contact with the spring, the tuning screw further configured to adjust within the hollow tube such that when the tuning screw is tightened, the tuning screw compresses the spring against the piston and when the tuning screw is loosened, the tuning screw reduces compression of the spring with the piston, the tuning screw further configured to pass the thread of the piston therethrough and a spacer configured to couple to the piston and extend through the coupling channel of the secondary mount body.
